(19) United States
(12) Patent Application Publication
(10) Pub. No.: US 2007/0198620 A1
(43) Pub. Date: Aug. 23, 2007

(54) Modeling Environment with Generally Accessible Variables for Dynamically Linked Mathematical Representations

(75) Inventors: Nikhil Nilakantan, Dallas, TX (US); Stephen Boatner Loe, Allen, TX (US); Gregory Thorne Springer, La Jolla, CA (US); Paul Daly, Plano, TX (US); Robert Charles Wellman Jenks, McKinney, TX (US); Charles Alan Donaldson, Rowlett, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/465,978

(22) Filed: Aug. 21, 2006

Related U.S. Application Data
(60) Provisional application No. 60/775,959, filed on Feb. 23, 2006.

(51) Int. Cl. G06F 15/00

(52) U.S. Cl. 708/200

(57) ABSTRACT

An electronic device capable of graphical data analysis is provided. The device includes a processor capable of manipulating numerical data and a graphical data. An input is provided for issuing instructions to the processor to manipulate the numerical data and graphical data. The device includes a memory device, a software program, and an output. The memory device is for storing graphical data and numerical data. The software program is stored in the memory device and is operable for dynamically linking the numerical data and graphical data, such that when the numerical data is updated the software automatically updates the linked graphical data, and vice versa. The output is operable for displaying graphical data and numerical data.

### CROSS-REFERENCE TO RELATED APPLICATIONS

This application claims priorty to the provisional application, U.S. Pat. App. No. 60/775,959, entitled “Modeling Environment with Generally Accessible Variables for Dynamically Linked Mathematical Representations”, filed on Feb. 23, 2006, by Nikhil Nilakantan, et al. The above-referenced provisional application is incorporated herein by reference.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to the collection and analysis of graphical and numerical data, and more particularly, but not by way of limitation, to a system and method for the dynamic manipulation of a common set of graphical and numerical data sets.

### BACKGROUND OF THE INVENTION

Handheld calculators are well known in the art and have been in use for many years. Although many handheld calculators are limited to simple algebraic computations such as addition, subtraction, multiplication, and division, there are several commercially available handheld calculators that are able to perform higher-level mathematical computations. For example, some handheld calculators allow a user to input a plurality of quadratic equations into the handheld calculator. The handheld calculator then graphs each of the equations on a coordinate plane and determines the intersection of the lines or curves created by the equations. Handheld calculators that perform these functions are manufactured by numerous companies including Texas Instruments.

### SUMMARY OF THE INVENTION

In one embodiment, an electronic device capable of graphical data analysis is provided. The device includes a processor capable of manipulating numerical data and a graphical data. An input is provided for issuing instructions to the processor to manipulate the numerical data and graphical data. The device includes a memory device, a software program, and an output. The memory device is for storing graphical data and numerical data. The software program is stored in the memory device and is operable for dynamically linking the numerical data and graphical data, such that when the numerical data is updated the software automatically updates the linked graphical data, and vice versa. The output is operable for displaying graphical data and numerical data.

In another aspect, an electronic calculator for mathematical analysis is provided. The electronic calculator includes a processor, a memory electrically coupled to the processor, and a display screen electrically coupled to the processor. The electronic calculator also includes a first and second cards and software. The first card is stored in memory and has a graphical environment and maintains graphical data. The second card is stored in memory and has a tabular environment and maintains numerical data. The software component is operable to link the first and second cards such that when the graphical data is updated the software component updates the numerical data stored in the memory and vice versa.

In yet another embodiment, a computer readable medium maintaining software instructions for data analysis is provided. The software instructions provide for dynamically linking graphical data and numerical data, and updating the graphical data to reflect changes made to numerical data. The software instructions further provide for updating the numerical data to reflect changes made to graphical data, and displaying the numerical data and graphical data.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof reference is now made to the following brief description, taken in connection with the accompanying drawings and detailed description, wherein like reference numerals represent tike parts.

FIG. 1 is an illustration of an overview of one embodiment of the present invention.

FIG. 2 is an example of a wave displayed on a handheld calculator that has been captured as graphical data.

FIG. 3 is an example of numerical data which includes data from several axes produced on the display of a handheld calculator and displayed as numerical data.

FIG. 4 is a block diagram of one embodiment of the present invention.

FIG. 5 is an example of an update system to dynamically link data

FIG. 6 is an example of an interface that was produced on the display of a handheld calculator that can be used to populate a numerical table from graphical data.

FIG. 7 illustrates a block diagram of a mobile device operable for some of the various embodiments of the present disclosure.

FIG. 8 illustrates an exemplary general purpose computer system suitable for implementing the several embodiments of the disclosure.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

This application contains subject-matter similar to U.S. patent application Ser. No. ______, entitled Dynamic Data Flow and Data Linking, Gregory Springer et al. inventors, Attorney Docket No. (TI-61634)(1962-30701), U.S. patent application No. ______, entitled Using a Document Model to Create and Maintain Dynamic Mathematic Representations Through Problem Spaces, Nikhil Nilakantan et al. inventors, Attorney Docket No. (Ti-62057)(1962-31101), all of which are filed on even date herewith; and U.S. patent application Ser. No. 11/360,258, entitled Tabular Environment that Supports Column Rules and Cell Rules, Nikhil Nilakantan, Attorney Docket No. (TI-62017)(1962-30800) filed on Feb. 23, 2006; all of which are incorporated herein by reference for all purposes.

The graphing functionality found in current electronic devices is limited to creating graphical data from equations, and the graphing functionality is not capable of creating equations or numerical data from graphical data. As used herein, the term graphical may include, but is not limited to, any non-text or non-alphanumeric data. Graphical or graphing also includes graphing geometric configurations and/or illustrations of the use of geometry. In some of the present embodiments, the present application teaches a system and method for dynamically linking and adjusting numerical data and graphical data. In an environment with both numerical data and graphical data, numerical data may be altered, resulting in a corresponding change in the graphical data. In an environment with more than one graphical data representation, the graphical data may be altered, resulting in a corresponding change in the numerical data. The present innovations teach a system and method to link different forms of data, and apply changes to both. Using the disclosed method, analysis of data can be conducted simultaneously across different representations of the same type of data.

One of the innovative embodiments in the disclosed % application is the ability to make multiple representations of graphical data stored in an electronic device and dynamically manipulate the graphical data. An electronic device includes things such as calculators, computers, and other electronic devices with data processing capabilities. Handheld calculators, or small, portable devices with internal memory, processing ability, and a proprietary operating system are directed primarily at mathematical computations and are one type of electronic device.

FIG. 1 is an illustration of an overview of one embodiment of the present invention. In block 10, a user creates graphical data in the form of a line using numerical data that represents the equation of a line on an electronic device. The example of the equation of the line is used for illustrative purposes only. The graphical representation could be made from any set of points descriptive of a mathematical function or any type of mathematical function, equation, or value. In block 12 the user selects the graphical data produced from the numerical data. In block 14, the user may shift the line or otherwise modify the graphical data. In block 16, the electronic device dynamically updates the numerical data to correspond with the new graphical data.

It is possible with the disclosed innovations not only to change numerical data with changes to graphical data, but also possible to make changes to graphical data based on changes to numerical data. In block 18, the user selects the numerical data and alters one of the elements of the equation of the line. In block 20, the electronic device dynamically updates the graphical data.

One of the innovations of the present invention is that manipulations can be preformed upon either the graphical data or the numerical data, and that the present invention can update the graphical data or the numerical data regardless of the order that the graphical data or the numerical data was updated.

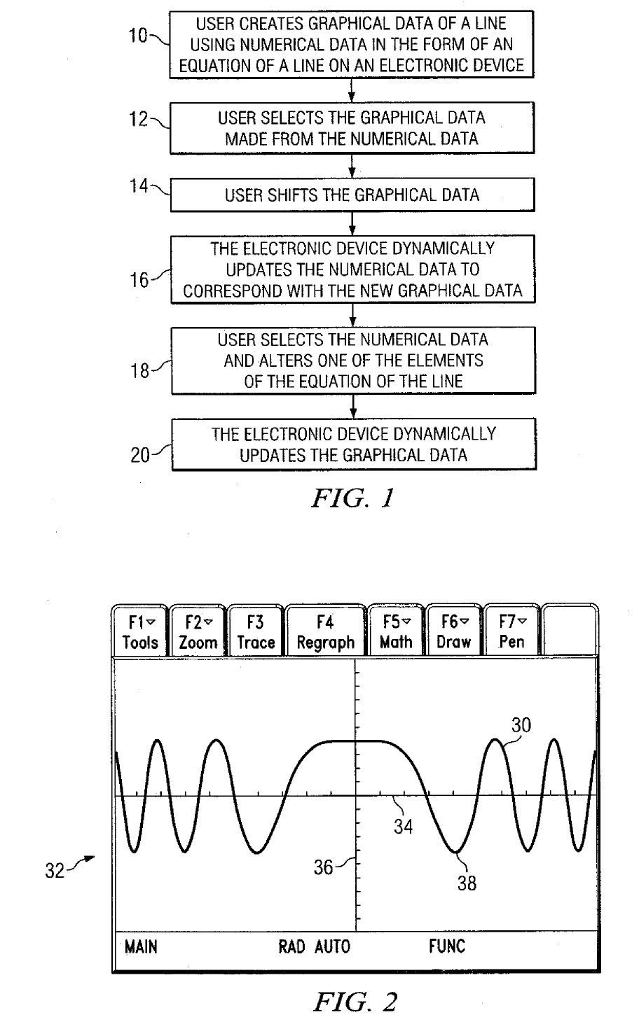

FIG. 2 is an example of a wave 30 that was produced on a display 32 of a handheld calculator (not shown) that has been captured as graphical data. The graphical data is a graphical data representation of the wave 30. The wave 30 shown is plotted on an x-axis 34 and a y-axis 36.

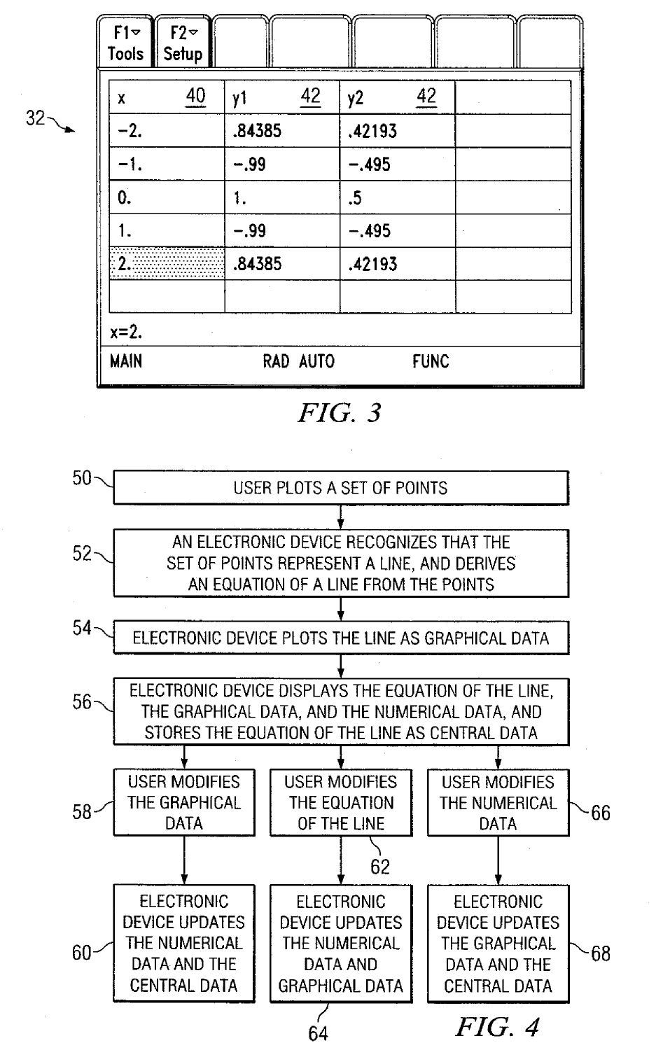

FIG. 3 is an example of numerical data that includes data from several axes 40, 42, and 44 that was produced on the display 32 of a handheld calculator (not shown) that has been captured as numerical data. Symbolic data used in a function or found in a particular expression (such as variables, functions, and constants) are considered to be numerical data. Numerical data is intended to refer to the numerical representation of data stored within the electronic device. For instance, the following equation is considered to be a representation of numerical data:

$${\int }_{3}^{x} ( {c}_{1} {e}^{- \frac{2}{2} t} sin ( \frac{\sqrt{2}}{2} t π ) + {c}_{2} {e}^{- \frac{2}{2} t} cos ( \frac{\sqrt{2}}{2} t ) ) d t$$

Thus in one embodiment, the present system provides for dynamically manipulating data that is simultaneously displayed in graphical data and numerical data forms, and allowing for the update of the data based upon changes to either the numerical data representation or the graphical data representation. The present system provides a powerful aid to students and professionals, as it allows for the dynamic manipulation of graphical data to be linked dynamically to a corresponding representation of the data in numerical data form. By using this innovative approach, mathematical analysis may be carried out on a particular set of data, through either graphical or numerical representations of the data. In addition, another of the innovative features of the present disclosure is the ability to take graphical data that may be manipulated by the user, and convert it into numerical data that is suitable for analysis.

FIG. 4 is a diagram of another embodiment of the present invention. In block 50, a user plots a set of points. This set of plots could be anything as simple as two (x,y) coordinates to any number of points along any type of coordinate system. It is envisioned that the user could use coordinates that make up three dimensions in the mathematical analysis.

In block 52, an electronic device recognizes that the set of points represent a line and derives an equation of a line from the points. The electronic device could make a determination that a more complex set of points represented a different function or relation, and therefore the present innovations are not limited to, for example, any particular function or relation. In block 54, the electronic device plots the line as graphical data. In block 56, the electronic device displays the equation of the line, the graphical data, and the numerical data, and stores the equation of the line as central data.

While central data is a type of numerical data, it has a specific role in the current innovations. When numerical data is entered into the electronic device over a specific domain and predetermined intervals (e.g., values for x from −10 to 10, sampled at each whole number), a relationship must be extrapolated in order to perform graphing of the numerical data. This relationship is stored in the electronic device as central data. When changes are made to any of the forms of the data (e.g. the central data, numerical data, or graphical data), corresponding changes are first made to the central data, which then propagates the changes to the other forms of the data. Since the central data is dynamically linked to both the graphical data and the numerical data, any changes made to the central data are immediately propagated to the other types of data.

If the user modifies graphical data, as in the embodiment shown by FIG. 4, those changes will be propagated to all other items using the graphical data. In block 58 of FIG. 4, the user modifies the graphical data. In response to this modification, the electronic device updates the numerical data and the central data in block 60.

If the user modifies the equation data, as in the embodiment shown by FIG. 4, those changes will be propagated to all other items using the equation data. In block 62 of FIG. 4, the user modifies the equation of the line. In response to this modification, the electronic device updates the numerical data and the graphical data in block 60.

If the user modifies numerical data, as in the embodiment shown by FIG. 4, those changes will be propagated to all other items using the numerical data. In block 66 of FIG. 4, the user modifies the numerical data. In response to this modification, the electronic device updates the graphical data and the central data in block 68.

In some embodiments, the electronic device, such as a calculator, may provide the user with work areas, which may be thought of as cards, in which to work problems and equations. Each of these work areas, or cards, may be defined as having a different environment. The different environments may include, for example, a graphical environment for mapping and graphing on a coordinate plane. One environment may be a tabular or cell based area for creating tables or values, formulas and/or other relationships between columns, rows, cells, and so on. Other environments my include scratch or note pads that may be used for notes regarding the numerical data, variables, and equations, for example. Still other environments may be textual, such as a text editor, for word problems that might include the values and variable that establish the problem. The graphical data relates to the graphical environment, the other environments, tabular/cell based, note or scratch/pad, and text editor are associated with the numerical data. These are just a few examples of different possible environments, and others will readily suggest themselves to one skilled in the art and are within the spirit and scope of the present disclosure.

The user of the calculator may then create and arrange or organize the different cards/environments to analyze and solve problems. For example, the user might setup three cards on the calculator for a particular problem: one card having a text environment containing a word problem with some numerical data; a second card having a tabular environment containing rows and columns of numerical data related to the word problem; and a graphical environment card with a graph illustrating the numerical data of the word problem mapped onto a coordinate plan. The present system is operable to dynamically links all these cards/environments related to a problem or problem space, such that a data, such as numerical data is modified in one card, the change is propagated to other cards. This may include linking and updating numerical data from one numerical data card/environment to another numerical data card/environment, but also includes linking and updating between numerical data card/environment and graphical data card/environments as well. Although in some of the disclosed embodiments only two cards may be shown and discussed together, any number of cards may be used or displayed together, and a single problem space may have any number of cards, such as hundreds or more.

The system provides the user with the ability to link the numerical data, such as in one card or environment, to the graphical data in another card or environment. A mechanism, such as a software component, is operable to monitor when either of the data is modified, determine any links that are established, and update any linked or associated data in the separate cards or environments, as well as updating the display. All the variables and/or data in a problem space are globally accessible to all the cards or environments within that problem space. Therefore the variables or data can be changed in any card or environment, and any linked data will be updated accordingly. The user can initiate the change or update to the data or variables, or the applications (card or environment) may initiate the change to the data or variables.

The user, via any application (such as a card or environment), can apply a constraint on a variable or data, and to the extent multiple constraints exist, a hierarchy of constraints might be useful in some instances. For example, where a problem analyzes area (such as Length×Width=Area), the user might add a constraint, such as in a tabular environment card, that the total Area may not exceed a particular value. If the user attempts to expand a rectangle that is graphed and displayed in the graphical area, such using a pointer and dragging to change the dimensions of the rectangle, the total area constraint might prohibit the user from making the rectangle larger than a particular size that would exceed the total. Area constraint. This is only one example and other more complex constraints or multiple constraints per problem or card may be used.

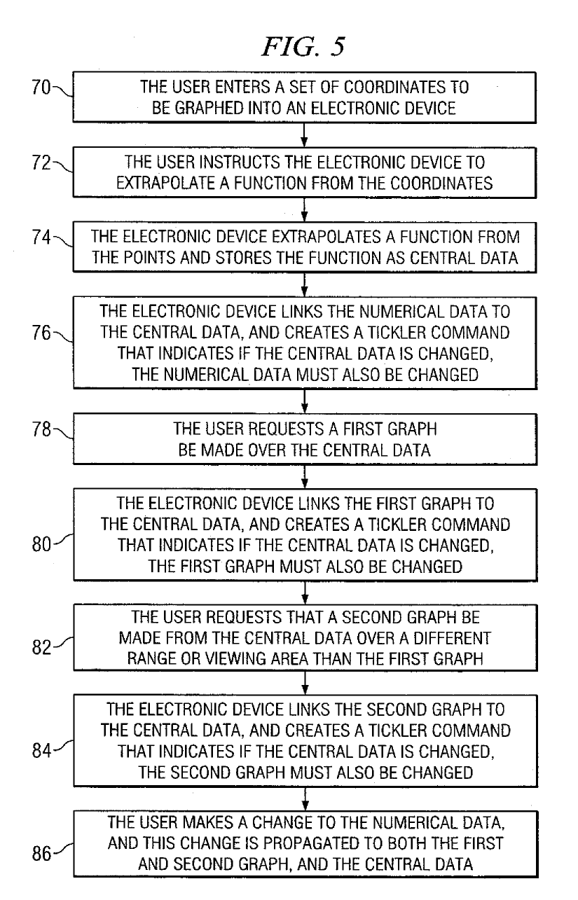

In some embodiments of the present invention, an ‘update system’ is used to dynamically update the system. FIG. 5 shows an example of this system. In this example, the user enters a set of coordinates to be graphed into an electronic device in block 70. Instead of using coordinates, the user could have entered graphical or other types of functional data. In block 72, the user instructs the electronic device to extrapolate a function from the coordinates. In block 74, the electronic device extra plates a function from the points and stores the function as central data. In block 76, the electronic device links the numerical data to the central data, and creates an update command that indicates that if the central data is changed, then the corresponding numerical data must also be changed. In block 78, the user requests a first, graph be made over the central data. In block 80, the electronic device links the first graph to the central data, and creates an update command that indicates that if the central data is changed, then the first graph must also be changed. In block 82, the user requests that a second graph be made from the central data over a different range or viewing area than the first graph. In block 84, the electronic device links the second graph to the central data, and creates an update command that indicates that if the central data is changed, the second graph must also be changed. In block 86, the user makes a change to the numerical data, and this change is propagated to both the first and second graph, and the central data.

One of the educational advantages of this form of data collection is to allow a student to better understand the elements of any given type of function or mathematical expression. For instance, in one type of function, such as shown in FIG. 2, the student could attempt to extrapolate a part of the function from the Whole. The student could zoom in or out of the function in one graphical display, make changes to discrete points of the function to create new functions, or change the function itself and see the changes both graphically and with discrete points presented in a tabular environment. In addition, the student can create new views of the numeric data to better understand certain parts of the graph. For instance, when looking at a graph which has a limit, a student could zoom in on the part of the graph which represents the limit to better understand the concept of a limit.

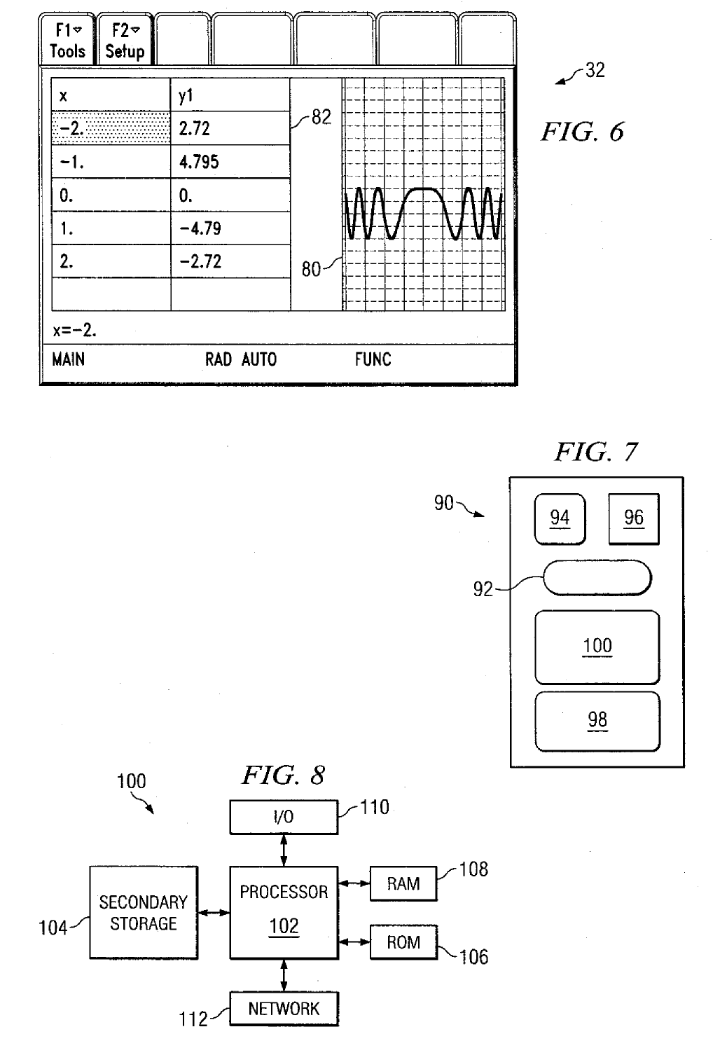

FIG. 6 is an example of an interface that was produced on the display 32 of a handheld calculator (not shown) that can be used to show both numerical data and graphical data simultaneously. The right side 80 of the display 32 is graphical data, or an illustration of a card having a graphical environment. The left side 82 of the display 32 is numerical data, or an illustration of a card having a tabular environment. A point may be selected on the right side 80 of the display 32, and a corresponding value for the coordinates of the point found on the right side 80 of the display 32 is populated into the left side 82 of the display 32. In this interface, moving a cursor over the graph and pressing a selection button will select the graph. The user may then drag a point on the graph to a new point, changing the function and the discrete values found at any particular point along the function.

Since graphical representations contain many different data points, the user may wish to define what points of data the user is interested in. For instance, the user, in referring to a plot such as found on the right side 80 of the display 32, want to see the values of Y when X is 1, 2, 3, and 4. The user could then, when he has changed the graphical data, see the new values of Y at those X points.

While the disclosed system and method envisioned by the present application may be implemented on a variety of electronic devices, one of the preferred devices is on a handheld calculator. A calculator is distinguishable from a general purpose computer in a number of ways. First, rather than the user interface being built around a keyboard, the interface of a calculator is built primary either around a keypad or other interface designed to promote the entry of mathematical data. For example, such calculators or scientific calculators may include keys, buttons, or indicia that are directed primarily toward more complex mathematical functions, such as sin, cosine, log, square root, and other mathematical functions that are not ordinarily found on non-calculators type devices, such as mathematical functions that go beyond the standard plus, minus, multiplication, and division features. Secondly, the handheld calculator typically operates using a propriety operating system directed primarily at mathematical operations. Yet another difference is the basic interaction of a calculator as opposed to the general computer. A handheld calculator is driven through a key menu option system where hardware keys are used as the primary method to invoke options and menus. This is in contrast to a general computer that incorporates a pointer system as the primary method of navigation. Pointers are usually driven by devices such as mice, touch screens, trackballs, or similar devices, and allow the user to virtually “point” at an option. Whereas with a calculator, the user presses a button to correspond to an option. However, some calculators may include such pointing devices. Persons of ordinary skill in the art are aware of other differences between handheld calculators and computers.

FIG. 7 shows an exemplary handheld mobile device 90, such as a calculator in one embodiment, for implementing one or more embodiments disclosed herein. All or portions of the systems and methods described above may be implemented on any handheld mobile device 90 such as is well known to those skilled in the art. The handheld mobile device 90 includes a processor 92 (which may be referred to as a central processor unit or CPU) that is coupled to a first storage area 94, a second storage area 96, an input device 98 such as a keypad, and an output device such as a display screen 100.

The processor 92 may be implemented as one or more CPU chips and may execute instructions, codes, computer programs, software instructions, or scripts that it accesses from the first storage area 94 or the second storage area 96. The first storage area 94 might be a non-volatile memory such as flash memory. Data for handheld mobile device 90 would typically be installed in the first storage area 94. The second storage area 96 might be firmware or similar type of memory. The first and or second storage areas 94 and 96 are examples of computer readable medium wherein software instructions might be stored. The device's operating system would typically be installed in

The present embodiment provides an open-ended mathematical problem model creation, linking to various cards within a problem space, and analysis. According to one embodiment, providing a common data store, such as the first and second data stores 94 and/or 96, combined with a generalized method of linking the data in those data stores 94, 96 provides a tool model creation and analysis that is very powerful in its combination of flexibility and ease of use. The generalized method of linking the data includes, in some embodiments, storing and linking data so as to be accessible by multiple cards and/or environments within a problem space.

When implemented on a computer, the system described above may be implemented on any device with sufficient processing power, memory resources, and network throughput capability to handle the necessary workload placed upon it. FIG. 8 illustrates a typical, general-purpose computer system: suitable for implementing one or more embodiments disclosed herein. The computer system 100 includes a processor 102 (which may be referred to as a central processor unit or CPU) that is in communication with memory devices including secondary storage 104, read only memory (ROM) 106, random access memory (RAM) 108, input/output (I/O) 110 devices, and network connectivity devices 112. The processor may be implemented as one or more CPU chips.

The secondary storage 104 is typically comprised of one or more disk drives or tape drives and is used for non-volatile storage of data and as an over-flow data storage device if RAM 108 is not large enough to hold all working data. Secondary storage 104 may be used to store programs which are loaded into RAM 108 when such programs are selected for execution. The ROM 106 is used to store instructions and perhaps data which are read during program execution. ROM 106 is a non-volatile memory device which typically has a small memory capacity relative to the larger memory capacity of secondary storage. The RAM 108 is used to store volatile data and perhaps to store instructions. Access to both ROM 106 and: RAM 108 is typically faster than to secondary storage 104.

I/O 110 devices may include printers, video monitors, liquid crystal displays (LCDs), touch screen displays, keyboards, keypads, switches, dials, mice, track balls, voice recognizers, card readers, paper tape readers, or other well-known input devices. Most general purpose computers are driven using a mouse, or pointer, based navigation system.

The network connectivity devices 112 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 112 devices may enable the processor 102 to communicate with an Internet or one or more intranets. With such a network connection, it is contemplated that the processor 102 might receive information from the network, or might output information to the network in the course of performing the above-described method steps. Such information, which is often represented as a sequence of instructions to be executed using processor 102, may be received from and outputted to the network, for example, in the form of a computer data signal embodied in a carrier wave

Such information, which may include data or instructions to be executed using processor 102 for example, may be received from and outputted to the network, for example, in the form of a computer data baseband signal or signal embodied in a carrier wave. The baseband signal or signal embodied in the carrier wave generated by the network connectivity 112 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 102 executes instructions, codes, computer programs, software instructions, and/or scripts which it accesses from hard disk, floppy disk, optical disk (these various disk based systems may all be considered secondary storage 104), ROM 106, RAM 108, or other computer readable medium and/or the network connectivity devices 112.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. An electronic device capable of graphical data analysis, comprising:
a processor capable of manipulating numerical data and a graphical data;
an input for issuing instructions to the processor to manipulate the numerical data and graphical data;
a memory device for storing graphical data and numerical data;
a software program stored in the memory device and operable for dynamically linking the numerical data and graphical data, such that when the numerical data is updated the software automatically updates the linked graphical data, and vice versa; and
an output operable for displaying graphical data and numerical data.

2. The electronic device of claim 1, wherein the electronic device output displays the graphical data using one coordinate system selected from the group consisting of polar, radian, and Cartesian coordinate.

3. The electronic device of claim 1, wherein the electronic device output is capable of simultaneously displaying more than one representation of data.

4. The electronic device of claim 1, wherein the electronic device is capable of extrapolating a mathematic function from numerical data and graphical data.

5. The electronic device of claim 4, wherein the electronic device is capable of storing the extrapolated mathematical function as central data in the memory device.

6. The device of claim 1, further comprising a second graphical data, wherein second graphical data is a representation of the numerical data over a range separate than that of graphical data.

7. The electronic device of claim 6, wherein the processor obtains third graphical data from user made changes to the graphical data.

8. The electronic device of claim 6, wherein the processor obtains numerical data from user changes to the first graphical data, second graphical area, or third graphical data.

9. A electronic calculator for mathematical analysis, comprising:
a processor;
a memory electrically coupled to the processor;
a display screen electrically coupled to the processor;
a first card stored in memory and having a graphical environment and maintaining graphical data;
a second card stored in memory and having a tabular environment and maintaining numerical data; and
a software component operable to link the first and second cards such that when the graphical data is updated the software component updates the numerical data stored in the memory and vice versa.

10. The electronic calculator of claim 9, further comprising a third card having a textual environment and maintaining numerical data, and a fourth card having a scratch pad environment and maintaining numerical data such that when data from one of the first, second, third, and fourth cards is modified, the software is operable to propagate the change to the linked data of the other cards, respectively.

11. The electronic calculator of claim 9, wherein the electronic calculator is capable of extrapolating a mathematic function from numerical data and graphical data and storing the extrapolated mathematical function as central data in the memory device.

12. The electronic calculator of claim 9, wherein the operating system of the electronic calculator is directed towards button navigation and operation rather than a pointer navigation system.

13. The electronic calculator of claim 9, wherein the display screen of the electronic calculator is capable of displaying both graphical data and numerical data simultaneously.

14. The electronic calculator of claim 9, wherein the processor uses an update system to dynamically update representations of data.

15. The electronic calculator of claim 13, wherein the electronic calculator is capable of creating a new representation of graphical data dynamically linked to the numerical data or graphical data.

16. A computer readable medium maintaining software instructions for data analysis, the software instructions comprising:
dynamically linking graphical data and numerical data;
updating the graphical data to reflect changes made to numerical data;
updating the numerical data to reflect changes made to graphical data; and
displaying the numerical data and graphical data.

17. The computer readable medium of claim 16, further comprising wherein the numerical data is maintained on a first card having one of a tabular environment, a scratch pad environment, a text editor environment.

18. The computer readable medium of claim 16, wherein the graphical and numerical data are displayed simultaneously.

19. The computer readable medium of claim 16, further comprising the step of storing numerical data in a memory of an electronic device, and displaying the numerical data and graphical data based upon the contents of the memory.

20. The computer readable medium of claim 19, further comprising the step of sharing the memory of the electronic device with other electronic devices, and updating the numerical data and graphical data when a change is made to the memory of the electronic device.
